(19) United States
(12) Patent Application Publication
(10) Pub. No.: US 2026/0267292 A1
(43) Pub. Date: Sep. 10, 2026

(54) SHOT TIMER

(71) Applicant: Feixue Liu, Shenzhen (CN)

(72) Inventor: Feixue Liu, Shenzhen (CN)

(21) Appl. No.: 19/657,221

(22) Filed: Apr. 24, 2026

(51) Int. Cl. G04F 1/00; A45F 5/02

(52) U.S. Cl. CPC G04F 1/005; A45F 5/021; A45F 2005/025

(57) ABSTRACT

A shot timer is provided, including a main machine configured to assist a user with timing during shooting training, and a mounting shell including a shell body with an accommodation groove and a mounting piece disposed on the shell body facing away the accommodation groove, the accommodation groove being configured to receive the main machine, the mounting piece being configured to attach to the user's body, and the shell body being configured to drive the main machine to rotate relative to the mounting piece. The shot timer can support both multi-person training assessment mode and single-person training mode, and can achieve angle adjustment of the main machine through the rotatable mounting piece, thereby meeting the needs of different users.

### TECHNICAL FIELD

The present disclosure relates to the technical field of auxiliary devices for shooting training, more particularly to a shot timer.

### BACKGROUND

In existing shooting training, to achieve more accurate training assessments, more and more auxiliary devices have been applied. Shot timer is one of the common auxiliary devices.

Conventional shot timers require operation by someone other than the shooter, which is suitable for multi-person training. However, during single-person training, the shooting trainee has to both operate the shot timer and quickly place it, which causes certain operational difficulties. Even though shot timers with clip structures have emerged, which can be clipped onto trainees' belts, their placement positions are relatively fixed, only meeting the needs of a small number of trainees. They cannot provide suitable placement positions for different trainees, hence cannot fully exert the auxiliary effects and are difficult to meet the requirements of usage. Therefore, it is necessary to provide an improved technical solution.

### SUMMARY

In view of the above, the present disclosure aims to address at least one of the technical problems in existing technologies. To this end, the present disclosure provides a shot timer. Specifically, a mounting shell capable of receiving a main machine is configured to attach to a user's body through a mounting piece, and the mounting shell is configured to drive the main machine to rotate relative to the mounting piece. In this way, the shot timer has an adjustable angle when worn by a user, being adaptable to users with different heights and body shapes, and significantly improving the adaptability. In addition, the shot timer features a simple structure and is easy to operate.

To this end, in a first aspect, an embodiment of the present disclosure provides a shot timer, including:

a main machine configured to assist a user with timing during shooting training; and

a mounting shell including a shell body with an accommodation groove and a mounting piece disposed on the shell body facing away the accommodation groove, the accommodation groove being configured to receive the main machine, the mounting piece being configured to attach to the user's body, and the shell body being configured to drive the main machine to rotate relative to the mounting piece.

Preferably, the shell body includes a back plate and a mounting wall extending forward from the back plate; the mounting wall and the back plate forms the accommodation groove; and the mounting piece is disposed on a rear side of the back plate.

Preferably, the back plate is provided with a first connection structure; the mounting piece includes a mounting clip and a second connection structure connected to the mounting clip; and the second connection structure is rotatably engaged with the first connection structure.

Preferably, the first connection structure includes a first connection ring disposed on the back plate; and the second connection structure includes a second connection ring rotatably engaged with the first connection ring.

Preferably, one of the first connection ring and the second connection ring is provided with a toothed ring, while the other is provided with an elastic toothed block capable of elastically engaging with the toothed ring.

Preferably, the first connection ring is provided as a hollow structure; the first connection ring includes a first side ring wall disposed on the back plate and located on a relative inner side, a second side ring wall disposed on the back plate and located on a relative outer side, and an upper ring wall connecting relative upper edges of the first side ring wall and the second side ring wall that are away from the back plate; the first side ring wall, the second side ring wall and the upper ring wall form an annular cavity; the first side ring wall is formed with a first opening, and the elastic toothed block is housed in the annular cavity; a front end of the elastic toothed block extends partially out of the first opening, while a rear end thereof abuts against the second side ring wall; and a relative outer side of the second connection ring is provided with the toothed ring.

Preferably, the elastic toothed block includes a spring and an abutting block sleeved on the spring; the abutting block extends partially out of the first opening, and the spring abuts against the second side ring wall; and/or

the upper ring wall is formed with a second opening in communication with the first opening; and the elastic toothed block is mounted in the annular cavity via the second opening.

Preferably, the second connection structure further includes a mounting portion located within the second connection ring; and the mounting clip is connected to the mounting portion.

Preferably, the mounting wall is formed by extension of two lateral edges and a lower edge of the back plate; and the accommodation groove is provided as a semi-enclosed structure, an upper side of the accommodation groove forming a first open portion, and a side opposite to the back plate forming a second open portion.

Preferably, the main machine is provided with a display screen on an upper side thereof, the display screen being disposed corresponding to the first open portion; and the main machine is provided with a button area on one side thereof away from the back plate, the button area being disposed corresponding to the second open portion.

The shot timer provided by the present disclosure is configured to assist shooting trainees with timing during training or assessment. Specifically, the main machine is configured to implement the main function of timing. In addition, the mounting shell capable of receiving the main machine is configured to attach to the user's body through the mounting piece, and the mounting shell is configured to drive the main machine to rotate relative to the mounting piece. In this way, the shot timer has an adjustable angle when worn by a user, supporting both multi-person and single-person training modes. In the single-person training mode, the shot timer is adaptable to users with different heights and body shapes, significantly improving the adaptability. In addition, the shot timer features a simple structure and is easy to operate, providing users with good experiences.

### BRIEF DESCRIPTION OF THE DRAWINGS

FIG. 1 is a perspective view of a shot timer according to an embodiment of the present disclosure.

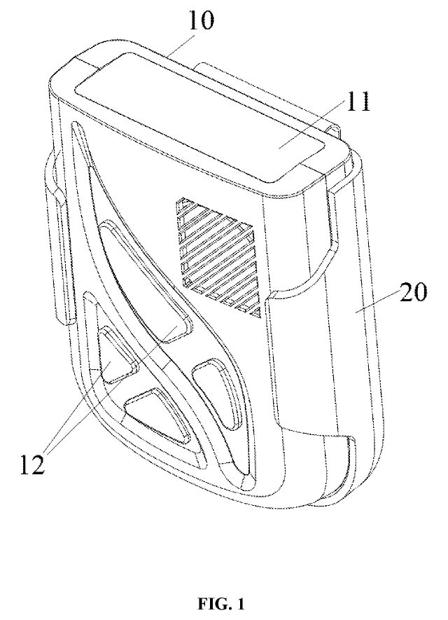

FIG. 2 is a perspective view of the shot timer in FIG. 1 from another angle.

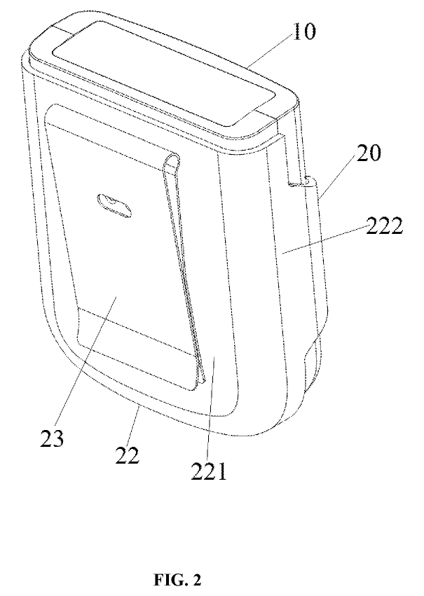

FIG. 3 is a perspective view of the shot timer in FIG. 2 with a main machine and a mounting shell separated.

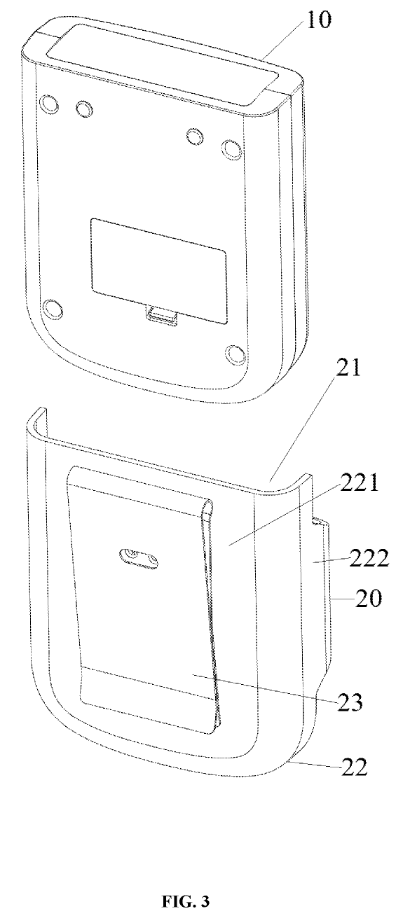

FIG. 4 is a perspective view of the shot timer in FIG. 2 in another state of usage.

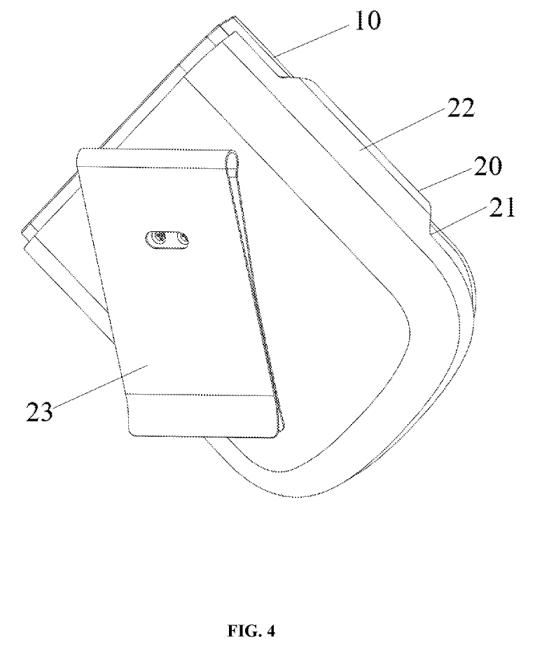

FIG. 5 is a perspective view of the mounting shell in FIG. 3 in an exploded state.

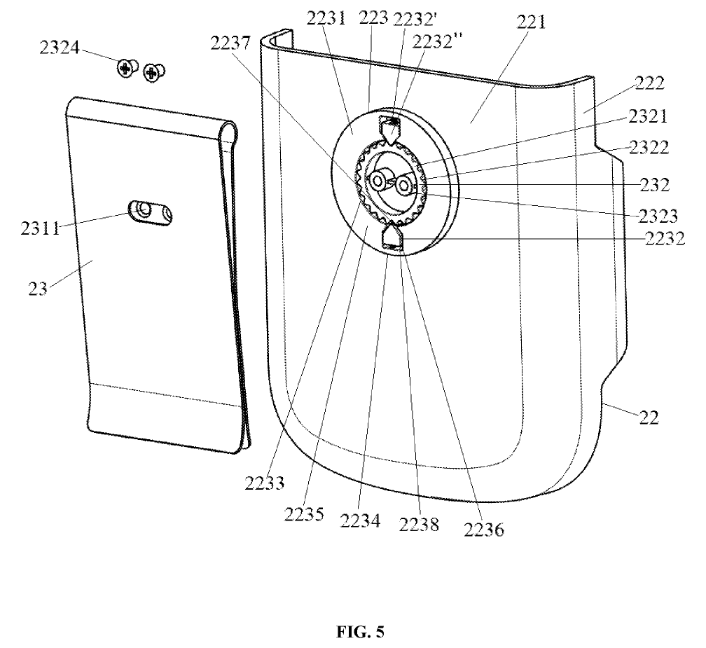

### DETAILED DESCRIPTION OF THE EMBODIMENTS

The embodiments of the present disclosure are described below in detail, examples of which are shown in the accompanying drawings on which the same or similar designators are used for representing the same or similar elements or elements having the same or similar functions. The following embodiments described in combination with the drawings are exemplary and intended to explain the present disclosure, and they should not be construed as a limitation on the present disclosure.

The following content provides many different embodiments or examples for implementing different structures of the present disclosure. In order to simplify the present disclosure, the components and settings of specific examples will be described below. Of course, they are examples merely and are not intended to limit the present disclosure. In addition, the present disclosure can repeat reference numerals and/or letters in different examples. This repetition is for the purpose of simplification and clarity, not indicating the relationship between the various embodiments and/or settings discussed herein. In addition, the present disclosure provides examples of various specific processes and materials, but those ordinary skill in the art should recognize the applicability of other processes and/or the use of other materials.

An embodiment of the present disclosure provides a shot timer, which can achieve accurate timing during shooting training or assessment, avoid manual errors, enable random switch between a multi-person training scenario and a single-person training scenario, and meet various needs of different users.

The shot timer specifically includes:

a main machine 10 configured to assist a user with timing during shooting training; and

a mounting shell 20 including a shell body 22 with an accommodation groove 21 and a mounting piece 23 disposed on the shell body 22 facing away the accommodation groove 21, the accommodation groove 21 being configured to receive the main machine 10, the mounting piece 23 being configured to attach to the user's body, and the shell body 22 being configured to drive the main machine 10 to rotate relative to the mounting piece 23.

Specifically, the main machine 10 is removably inserted into the accommodation groove 21. When the main machine 10 is inserted, an application scenario of user self-service control can be achieved during single-person training, such as single-person self-service training. When the main machine 10 is removed, an application scenario of operation by other personnel can be achieved during single-person training or multi-person training, such as shooting assessment. In addition, the shell body 22 of the mounting shell 20 is rotatably connected to the mounting piece 23, whereby the mounting shell 20 can drive the main machine 10 to adjust angle, meeting various needs of different users on operation angles due to different heights and body shapes, and improving the expandability of the device.

Specifically, the mounting piece 23 preferably is attached to a user's belt, which can be a regular belt or a tactical belt. However, it is understandable that the actual attaching position is not limit thereto, for example, it can be attached to an edge of a pocket.

Further, the shell body 22 includes a back plate 221 and a mounting wall 222 extending forward from the back plate 221; the mounting wall 222 and the back plate 221 form the accommodation groove 21; and the mounting piece 23 is disposed on a rear side of the back plate 221. In the present embodiment, the shell body 22 is provided as a simple structure, facilitating insertion and removal. It is understandable that the structure of the shell body 22 is not limited thereto. The shell body 22 and the main machine 10 can also be provided with mating mounting structures respectively, for example, the main machine 10 is provided with a mounting portion that can be received by the accommodation groove 21 to achieve connection therebetween.

Further, the back plate 221 is provided with a first connection structure 223; the mounting piece 23 includes a mounting clip 231 and a second connection structure 232 connected to the mounting clip 231; and the second connection structure 232 is rotatably engaged with the first connection structure 223. In the present embodiment, the back plate 221 and the mounting piece 23 are respectively provided with connection structures that rotatably engage with one another. It understandable that the connection structures that rotatably engage with one another can be an integrated structure on the back plate 221 or the mounting clip 231, where the back plate 221 and the mounting clip 231 are directly rotatably engaged, for example, a mating structure including a round hole and a round shaft is provided.

Further, in a preferred embodiment, the first connection structure 223 includes a first connection ring 2231 disposed on the back plate 221, and the second connection structure 232 includes a second connection ring 2321 rotatably engaged with the first connection ring 2231. In the present embodiment, the connection structures are provided as mating ring structures, allowing enlargement of area of the rotation mechanism, whereby increasing the rotatable connection area between the mounting piece 23 and the back plate 221, effectively improving the stability of the rotation structure, and avoiding damages. Specifically, the first connection ring 2231 is disposed on a relative outer side of the second connection ring 2321, that is, an inner side of the first connection ring 2231 is rotatably engaged with an outer side of the second connection ring 2321. It is understandable that the relative positional relationship therebetween is adjustable, that is, the first connection ring 2231 is disposed on the relative inner side, while the second connection ring 2321 is disposed on the relative outer side. In addition, for the connection ring located on the relative inner side, the overall structure is not limited to a ring structure either, as long as it has a circular structure mating with the connection ring located on the outer side, for example, the whole body can be a disc structure whose outer ring structure is rotatably connected to the inner side of the other connection ring.

Further, one of the first connection ring 2231 and the second connection ring 2321 is provided with a toothed ring 2322, while the other is provided with an elastic toothed block 2232 capable of elastically engaging with the toothed ring 2322. In the present embodiment, by providing the toothed ring 2322 to engage with the toothed ring 2322, rotational damping can be generated during a rotation process and snap-fit positioning can be achieved when stopped, whereby the shell body 22 and the mounting piece 23 can be rotated to any desired angle and remain stable in that position.

Further, the first connection ring 2231 is provided as a hollow structure. The first connection ring 2231 includes a first side ring wall 2233 disposed on the back plate 221 and located on a relative inner side, a second side ring wall 2234 disposed on the back plate 221 and located on a relative outer side, and an upper ring wall 2235 connecting relative upper edges of the first side ring wall 2233 and the second side ring wall 2234 that are away from the back plate 221. The first side ring wall 2233, the second side ring wall 2234 and the upper ring wall 2235 form an annular cavity 2236. The first side ring wall 2233 is formed with a first opening 2237; the elastic toothed block 2232 is housed in the annular cavity 2236; and a front end of the elastic toothed block 2232 extends partially out of the first opening 2237, while a rear end thereof abuts against the second side ring wall 2234. A relative outer side of the second connection ring 2321 is provided with the toothed ring 2322. In the present embodiment, the first connection ring 2231 is disposed on the relative outer side, while the second connection ring 2321 is disposed on the relative inner side. The first connection ring 2231 is provided with the elastic toothed block 2232 inwardly, and the second connection ring 2321 is provided with the toothed ring 2322 outwardly, thereby achieving rotatable engagement. It is understandable that the positions of the elastic toothed block 2232 and the toothed ring 2322 can be interchanged, that is, the inner side of the first connection ring 2231 is provided with the toothed ring 2322, while the outer side of the second connection ring 2321 is provided with the elastic toothed block 2232, as long as a tooth engagement structure is satisfied.

Further, in a preferred embodiment, the elastic toothed block 2232 includes a spring 2232' and an abutting block 2232'' sleeved on the spring 2232'; the abutting block 2232'' extends partially out of the first opening 2237; and the spring 2232' abuts against the second side ring wall 2234. In the present embodiment, specifically, the elastic toothed block 2232 is provided as a mating structure including the spring 2232' and the abutting block 2232'', which can keep long-term stability. It is understandable that in other embodiments, the elastic toothed block 2232 can also be provided as a rubber structure or an elastic metal sheet structure.

Further, the upper ring wall 2235 is formed with a second opening 2238 in communication with the first opening 2237; and the elastic toothed block 2232 is mounted in the annular cavity 2236 via the second opening 2238. In the present embodiment, the elastic toothed block 2232 can be mounted into or removed from the annular cavity via the second opening 2238, facilitating inspection and replacement in case of related structural damage.

Further, the second connection structure 232 further includes a mounting portion 2323 located within the second connection ring 2321; and the mounting clip 231 is connected to the mounting portion 2323. Specifically, the mounting portion 2323 is provided as a bar-shaped structure located inside the second connection ring 2321, and the bar-shaped structure is formed with a mounting hole, which specifically can be a screw hole. Correspondingly, the mounting clip 231 is formed with a through hole 2311 and further includes a locking fastener 2324, which specifically can be a screw. The locking fastener 2324 passes through the through hole 2311 to be fastened to the mounting portion 2323, achieving fixed mounting between the mounting clip 231 and the second connection structure 232.

Further, the mounting wall 222 is formed by extension of two lateral edges and a lower edge of the back plate 221; the accommodation groove 21 is provided as a semi-enclosed structure; an upper side of the accommodation groove 21 forms a first open portion, and a side opposite to the back plate 221 forms a second open portion.

Further, the main machine 10 is provided with a display screen 11 on an upper side thereof; the display screen 11 is disposed corresponding to the first open portion; the main machine 10 is provided with a button area 12 on one side thereof away from the back plate 221; and the button area 12 is disposed corresponding to the second open portion.

In addition, the main machine 10 is further provided with a buzzer, a voice control sensor and a main control unit. The operation principle of the main machine for shooting assistance is as follows.

Single-person training mode: before drawing a gun, a user presses the start button and waits for two seconds until the buzzer emits a "beep" sound. Upon hearing the "beep" sound, the user begins drawing and shooting. When the sound of gunshot is detected, the sensor is triggered to record the elapsed time between the "beep" sound and the detected gunshot sound. For continuous shooting, multiple gunshot times are recorded and displayed on the display screen.

Double training mode: the main machine 10 is held by an assistant or coach. When the coach presses the start button, the buzzer immediately emits a "beep" sound. Alternatively, the sound can be disabled, and the holder issues a "ready to fire" command while pressing the start button to begin timing. The sensor responds to the gunshot and records the time.

Specifically, the displayed time is the elapsed time between the "beep" sound and the response to the gunshot, minus the sound propagation time and the processor's processing time. The live round gunshot determination is based on sound amplitude; and the blank round gunshot determination is based on the impact frequency range of the unloaded gun and the impact sound waveform. The sensor is preferably a piezoelectric sensor.

The shot timer provided by the present disclosure is configured to assist shooting trainees with timing during training or assessment. Specifically, the main machine 10 is configured to implement the main function of timing. In addition, the mounting shell 20 capable of receiving the main machine 10 is configured to attach to the user's body through the mounting piece 23, and the mounting shell 20 is configured to drive the main machine 10 to rotate relative to the mounting piece. In this way, the shot timer has an adjustable angle when worn by a user, supporting both multi-person and single-person training modes. In the single-person training mode, the shot timer is adaptable to users with different heights and body shapes, significantly improving the adaptability. In addition, the shot timer features a simple structure and is easy to operate, providing users with good experiences.

In the description of the present specification, terms such as “one embodiment”, “some embodiments”, “example”, “specific example”, or “some examples” mean that the specific features, structures, materials, or features described in combination with the embodiment or example are included in at least one embodiment or example of the present disclosure. In the specification, indicative expressions of the above terms do not necessarily refer to the same embodiments or examples. Moreover, the specific features, structures, materials or features described may be combined in an appropriate manner in any one or more embodiments or examples. In addition, those skilled in the art can combine the different embodiments or examples described in the specification with the features of the different embodiments or examples if no conflict is caused.

Although the embodiments of the present disclosure have been illustrated and described above, it is understandable for the ordinary skill in the art that various changes, modifications, substitutions and alternations can be made to these embodiments without departing from the spirit and principle of the present disclosure. The scope covered by the present disclosure is defined by the claims appended hereinafter and equivalents thereof.

What is claimed is:

1. A shot timer, comprising:
a main machine configured to assist a user with timing during shooting training; and
a mounting shell comprising a shell body with an accommodation groove and a mounting piece disposed on the shell body facing away the accommodation groove, the accommodation groove being configured to receive the main machine, the mounting piece being configured to attach to the user's body, and the shell body being configured to drive the main machine to rotate relative to the mounting piece.

2. The shot timer according to claim 1, wherein the shell body comprises a back plate and a mounting wall extending forward from the back plate, the mounting wall and the back plate forming the accommodation groove, and wherein the mounting piece is disposed on a rear side of the back plate.

3. The shot timer according to claim 2, wherein the back plate is provided with a first connection structure, the mounting piece comprising a mounting clip and a second connection structure connected to the mounting clip, and the second connection structure being rotatably engaged with the first connection structure.

4. The shot timer according to claim 3, wherein the first connection structure comprises a first connection ring disposed on the back plate, and wherein the second connection structure comprising a second connection ring rotatably engaged with the first connection ring.

5. The shot timer according to claim 4, wherein one of the first connection ring and the second connection ring is provided with a toothed ring, while the other is provided with an elastic toothed block capable of elastically engaging with the toothed ring.

6. The shot timer according to claim 5, wherein the first connection ring is provided as a hollow structure, the first connection ring comprising a first side ring wall disposed on the back plate and located on a relative inner side, a second side ring wall disposed on the back plate and located on a relative outer side, and an upper ring wall connecting relative upper edges of the first side ring wall and the second side ring wall that are away from the back plate, wherein the first side ring wall, the second side ring wall and the upper ring wall form an annular cavity; wherein the first side ring wall is formed with a first opening, the elastic toothed block being housed in the annular cavity, a front end of the elastic toothed block extending partially out of the first opening, while a rear end thereof abutting against the second side ring wall; and wherein a relative outer side of the second connection ring is provided with the toothed ring.

7. The shot timer according to claim 6, wherein the elastic toothed block comprises a spring and an abutting block sleeved on the spring, the abutting block extending partially out of the first opening, and the spring abutting against the second side ring wall; and/or,
wherein the upper ring wall is formed with a second opening in communication with the first opening, the elastic toothed block being mounted in the annular cavity via the second opening.

8. The shot timer according to claim 6, wherein the second connection structure further comprises a mounting portion located within the second connection ring, the mounting clip being connected to the mounting portion.

9. The shot timer according to claim 2, wherein the mounting wall is formed by extension of two lateral edges and a lower edge of the back plate, the accommodation groove being provided as a semi-enclosed structure, an upper side of the accommodation groove forming a first open portion, and a side opposite to the back plate forming a second open portion.

10. The shot timer according to claim 9, wherein the main machine is provided with a display screen on an upper side thereof, the display screen being disposed corresponding to the first open portion; and wherein the main machine is provided with a button area on one side thereof away from the back plate, the button area being disposed corresponding to the second open portion.
